(19) United States
(12) Patent Application Publication
(10) Pub. No.: US 2025/0202032 A1
(43) Pub. Date: Jun. 19, 2025

(54) BATTERY MODULE AND BATTERY PACK INCLUDING THE SAME

(71) Applicants: Hyundai Motor Company, Seoul (KR); Kia Corporation, Seoul (KR)

(72) Inventors: Seok Eun Yoon, Seoul (KR); In Gook Son, Incheon (KR); Young Hoo Oh, Daejeon (KR); Yu Ri Oh, Hwaseong-si (KR); Hyun Chang Kang, Seoul (KR)

(21) Appl. No.: 18/923,096

(22) Filed: Oct. 22, 2024

(30) Foreign Application Priority Data
Dec. 13, 2023 (KR) 10-2023-0181249

(51) Int. Cl. H01M 50/342; H01M 50/204; H01M 50/258; H01M 50/358; H01M 50/367; H01M 50/383

(52) U.S. Cl. CPC H01M 50/3425; H01M 50/204; H01M 50/258; H01M 50/358; H01M 50/367; H01M 50/383; H01M 2200/20

(57) ABSTRACT

An embodiment battery module includes a plurality of battery cells arranged in a first direction, a module housing covering the plurality of battery cells on a side of the plurality of battery cells in a second direction crossing the first direction, the module housing including a venting frame defining a venting hole, and a side cover supported by the venting frame and covering the side of the plurality of battery cells in the second direction, wherein the side cover includes a perforated part including a plurality of perforated areas disposed along a periphery of an area facing the venting hole and spaced apart from each other.

### CROSS-REFERENCE TO RELATED APPLICATIONS

This application claims the benefit of Korean Patent Application No. 10-2023-0181249, filed on Dec. 13, 2023, which application is hereby incorporated herein by reference.

### TECHNICAL FIELD

The present disclosure relates to a battery module and a battery pack including the same.

### BACKGROUND

Recently, as awareness of the crisis over the environment and depletion of oil resources has increased, research and development on electric vehicles that are eco-friendly vehicles has been highlighted. Electric vehicles (hereinafter referred to as “vehicles”) include plug-in hybrid electric vehicles (PHEVs), battery electric vehicles (BEVs), and fuel cell electric vehicles (FCEVs).

An electric vehicle may include a battery pack having a battery module and a battery pack housing that supports the battery module. Meanwhile, an electric vehicle uses battery cells in a battery module as a power source, and when a fire occurs in the battery module, there is a risk of thermal runaway occurring.

Accordingly, recently, there is a need for an electric vehicle that may reduce heat transfer in the battery module that causes thermal runaway when a fire occurs in the battery module of the electric vehicle.

### SUMMARY

Embodiments of the present disclosure can solve problems occurring in the prior art while advantages achieved by the prior art are maintained intact.

An embodiment of the present disclosure provides a battery pack that may guide fluid generated in an interior of a battery module to an outside of the battery module and a battery pack housing.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, a battery module includes a plurality of battery cells arranged in a first direction, a module housing covering the plurality of battery cells on a side of the plurality of battery cells in a second direction crossing the first direction, and including a venting frame defining a venting hole, and a side cover supported by the venting frame and covering the side of the plurality of battery cells in the second direction, and the side cover includes a perforated part including a plurality of perforated areas disposed along a periphery of an area facing the venting hole and spaced apart from each other or a notch part having a thickness being smaller than that of a periphery thereof.

The perforated part may include a first perforated part extending along a third direction crossing the first direction and the second direction and a pair of second perforated parts extending from opposite ends of the first perforated part in a direction crossing the first perforated part.

The pair of second perforated parts may extend from the opposite ends of the first perforated part in the first direction or an opposite direction to the first direction.

The pair of second perforated parts may extend from the opposite ends of the first perforated part, the pair of second perforated parts becoming closer to or more distant from each other as they go in the first direction or in an opposite direction to the first direction.

The perforated part may include a third perforated part connecting two opposite ends of the pair of second perforated parts, which are disposed on opposite sides from ends of the second perforated parts, that are connected to the first perforated part, and a ratio of a section in which the plurality of perforated areas are disposed in the first perforated part to a length of the first perforated part may be greater than a ratio of a section in which the plurality of perforated areas are disposed in the third perforated part to a length of the third perforated part.

The notch part may include a first notch part extending along the third direction crossing the first direction and the second direction and a pair of second notch parts extending from opposite ends of the first notch part in a direction crossing the first notch part.

The pair of second notch parts may extend from the opposite ends of the first notch part in the first direction or an opposite direction to the first direction.

The pair of second notch parts may extend from the opposite ends of the first notch part, the pair of second notch parts becoming closer to or more distant from each other as they go in the first direction or in an opposite direction to the first direction.

The notch part may include a third notch part connecting two opposite ends of the pair of second notch parts which are formed on opposite sides to ends of the second notch parts which are connected to the first notch part, and a thickness of the third notch part may be formed to be greater than a thickness of the first notch part.

According to another embodiment of the present disclosure, a battery pack includes a battery pack housing defining a module accommodating space in an interior thereof and a battery module accommodated in the module accommodating space. The battery module may include a plurality of battery cells arranged in a first direction, a module housing covering the plurality of battery cells on a side of the plurality of battery cells in a second direction crossing the first direction, and including a venting frame defining a venting hole, and a side cover supported by the venting frame and covering a side of the plurality of battery cells in the second direction, and a perforated part including a plurality of perforated areas disposed along a periphery of an area facing the venting hole and spaced apart from each other or a notch part having a thickness that is smaller than that of a periphery of the notch part.

The battery pack housing may include a base plate that supports the battery module and a support member supported by the base plate and extending in the first direction or the second direction to partition the module accommodating space, and the support member may define a venting passage in an interior thereof, the venting passage being opened toward the venting hole of the battery module accommodated in the module accommodating space to be communicated with the venting hole.

The support member may include a first support member extending in the first direction and a second support member crossing the first support member and extending in the second direction, each of the first support member and the second support member may define a first venting passage extending in the first direction and a second venting passage communicated with the first venting passage and extending in the second direction, and the first support member may cover an outside of the side cover.

The perforated part may include a first perforated part extending along a third direction crossing the first direction and the second direction and second perforated parts extending from opposite ends of the first perforated part in a direction crossing the first perforated part to face an opposite direction to the second venting passage.

A plurality of second support members may be disposed to be spaced apart from each other along the first direction, and the second perforated parts may extend from the opposite ends of the first perforated part toward an opposite direction to a closed second support member from among the plurality of second support members.

The notch part may include a first notch part extending along a third direction crossing the first direction and the second direction and a pair of second notch parts extending from opposite ends of the first notch part in a direction crossing the first notch part to face an opposite direction to the second venting passage.

A plurality of second support members may be disposed to be spaced apart from each other along the first direction, and the second notch parts may extend from the opposite ends of the first notch part toward an opposite direction to a closest second support member from among the plurality of second support members.

The battery module may include a first battery module and a second battery module disposed to face each other with the first support member being interposed therebetween, and the first venting passage of the first support member may be communicated with a first venting hole of the first battery module and a second venting hole of the second battery module.

The first venting passage may include a first module venting passage communicated with the first venting hole of the first battery module and a second module venting passage communicated with the second venting hole of the second battery module, and the first support member may include a first support wall, a second support wall spaced downward apart from the first support wall, and a partition wall connecting the first support wall and the second support wall and separating the first module venting passage and the second module venting passage.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 is a perspective view of a battery pack according to an embodiment of the present disclosure;

FIG. 2 is an exploded perspective view of a battery pack according to an embodiment of the present disclosure;

FIG. 3 is a perspective view of a battery pack housing according to an embodiment of the present disclosure;

FIG. 4 is a plan view of a battery pack housing and a battery pack according to an embodiment of the present disclosure;

FIG. 5 is a perspective view of a battery module according to an embodiment of the present disclosure;

FIG. 6 is a transverse cross-sectional view of a battery module according to an embodiment of the present disclosure;

FIG. 7 is a schematic view of a side cover having a perforated part according to an embodiment of the present disclosure;

FIG. 8 is a schematic view of a side cover having a perforated part according to another embodiment of the present disclosure;

FIG. 9 is a schematic view of a side cover having a perforated part according to another embodiment of the present disclosure;

FIG. 10 is a schematic view of a side cover having a notch part according to an embodiment of the present disclosure;

FIG. 11 is a schematic view of a side cover having a notch part according to another embodiment of the present disclosure;

FIG. 12 is a schematic view of a side cover having a notch part according to another embodiment of the present disclosure;

FIG. 13 is a longitudinal cross-sectional view taken along line A-A′ illustrated in FIG. 4 when a fire occurs in a first battery module of an embodiment of the present disclosure;

FIG. 14 is a schematic view of a side cover having a perforated part according to another embodiment of the present disclosure;

FIG. 15 is a schematic view of a side cover having a perforated part according to another embodiment of the present disclosure;

FIG. 16 is a schematic view of a side cover having a notch part according to another embodiment of the present disclosure;

FIG. 17 is a longitudinal cross-sectional view of the battery pack taken along line A-A′ illustrated in FIG. 4 when a fire occurs in a second battery module in another embodiment of the present disclosure;

FIG. 18 is a schematic view of a cover area that closes a first module venting passage according to an embodiment of the present disclosure; and

FIG. 19 is a longitudinal cross-sectional view taken along line B-B′ illustrated in FIG. 4.

### DETAILED DESCRIPTION OF ILLUSTRATIVE EMBODIMENTS

Hereinafter, some embodiments of the present disclosure will be described in detail with reference to the attached drawings so that those skilled in the art may easily implement the present disclosure. When adding reference numerals to components in each drawing, it should be noted that identical components are given the same reference numerals as much as possible even if they are shown in different drawings. Additionally, in describing embodiments of the present invention, when it is determined that detailed descriptions of related known configurations or functions may impede understanding of the embodiments of the present invention, detailed descriptions thereof will be omitted.

Furthermore, in describing the components of the embodiments of the present disclosure, terms such as first, second, “A”, “B”, (a), and (b) may be used. The terms are simply for distinguishing the components, and the essence, the sequence, and the order of the corresponding components are not limited by the terms. Unless defined differently, all the terms including technical or scientific terms have the same meanings as those generally understood by a person of ordinary skill in the art to which the present disclosure pertains. The terms, such as the terms defined in dictionaries, which are generally used should be construed to coincide with the context meanings of the related technologies, and they are not to be construed as having ideal or excessively formal meanings unless explicitly defined in the present disclosure.

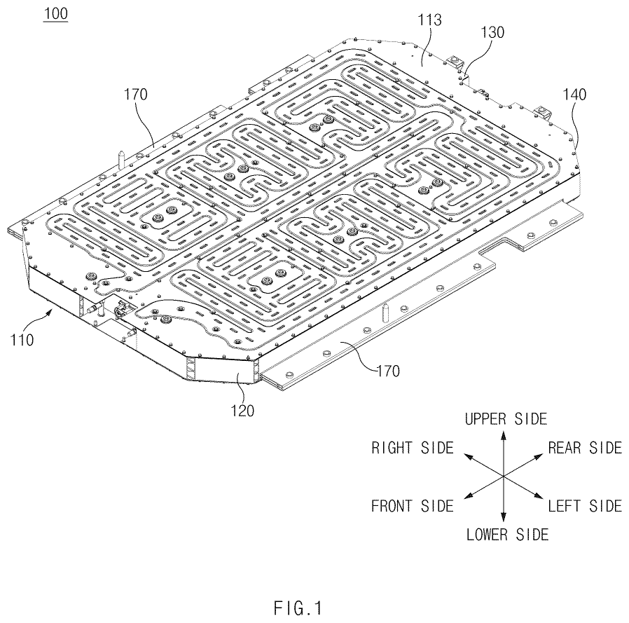

Hereinafter, embodiments of the present disclosure will be described in detail with reference to FIGS. 1 to 19.

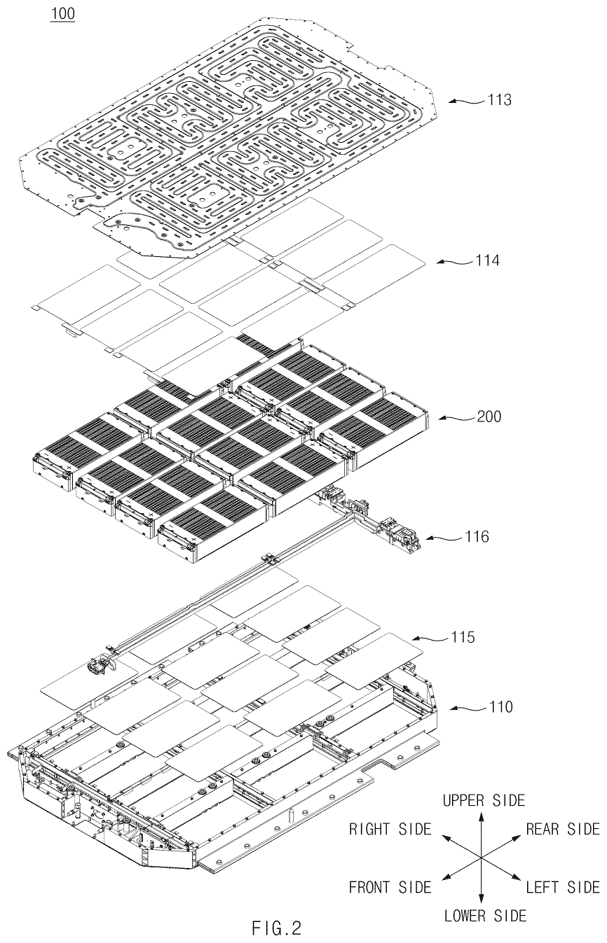

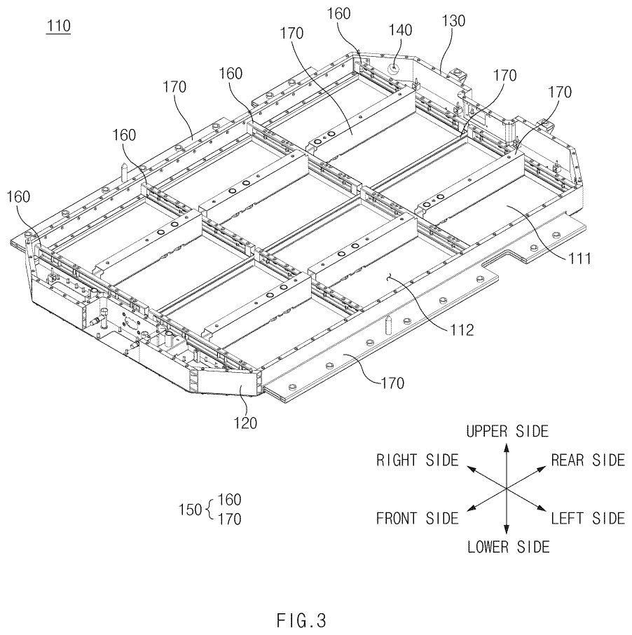

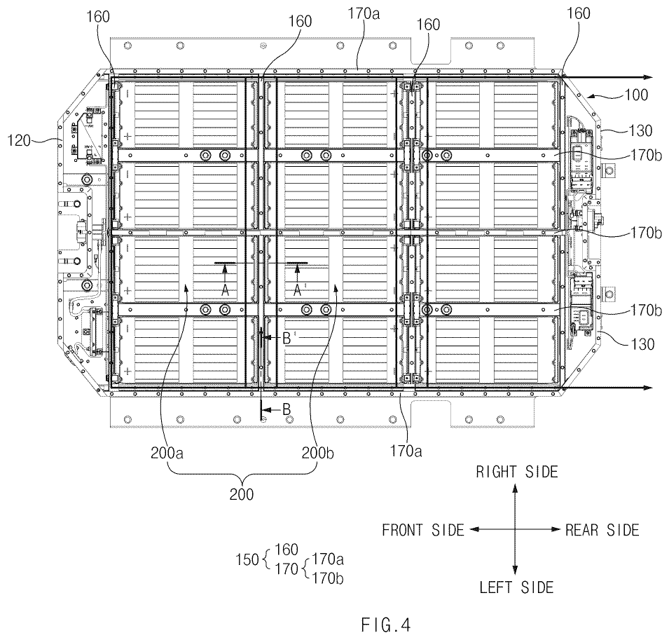

FIG. 1 is a perspective view of a battery pack according to an embodiment of the present disclosure. FIG. 2 is an exploded perspective view of the battery pack according to an embodiment of the present disclosure. FIG. 3 is a perspective view of a battery pack housing according to an embodiment of the present disclosure. FIG. 4 is a plan view of the battery pack housing and a battery pack according to an embodiment of the present disclosure.

Referring to FIGS. 1 to 4, a battery pack 100 may be mounted in an interior of an electric vehicle to transmit power of the electric vehicle. The battery pack 100 may include a battery module 200 and a battery pack housing 110 that covers the battery module 200.

The battery pack housing 110 may define a module accommodating space 112 in an interior thereof, and the battery module 200 may be accommodated in the module accommodating space 112.

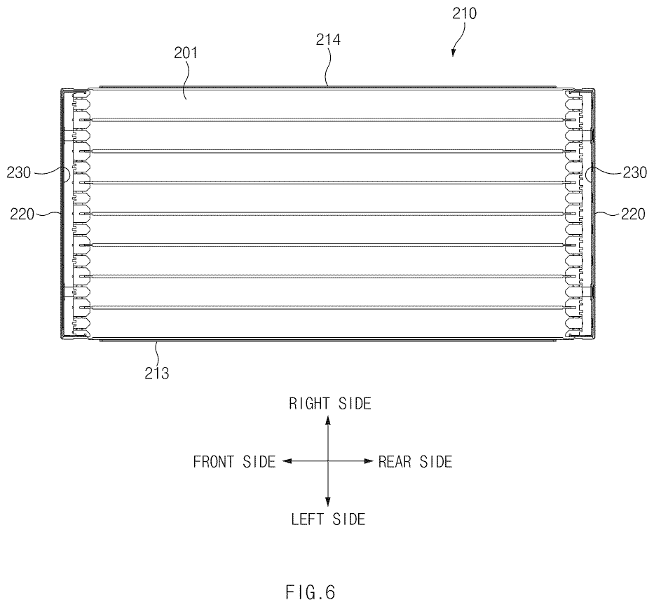

The battery module 200 may include a plurality of battery cells 201 (see FIG. 6). The battery cells 201 may be lithium-ion batteries, but the present disclosure is not limited thereto. The plurality of battery cells 201 may be used in the form of a battery module to be protected from an external impact, heat, vibration, or the like or to provide high electric power. The plurality of battery modules 200 may be supported by the battery pack housing 110 while being spaced apart from each other in a forward/rearward direction or a leftward/rightward direction.

The battery pack housing 110 may include a base plate 111 that is disposed on a lower side of the battery module 200 and supports the battery module 200. A lower cooling water channel may be formed in the base plate 111 to cool the battery module 200.

A lower heat transfer member 115 may be provided between the base plate 111 and the battery module 200. The lower heat transfer member 115 may contact a lower surface of the battery module 200 to absorb heat from the battery module 200 and may transfer the heat to the lower cooling water channel of the base plate 111.

The battery pack 100 may include a pack cover 113 that is coupled to the battery pack housing 110 and covers an upper side of the battery module 200. An upper cooling water channel for cooling the battery module 200 may be formed in the pack cover 113.

An upper heat transfer member 114 may be provided between the pack cover 113 and the battery module 200. The upper heat transfer member 114 may contact an upper surface of the battery module 200 to receive heat from the battery module 200 and transfer the heat to the upper cooling water channel of the pack cover 113.

The battery pack housing 110 may include a front member 120 that is coupled to a front part of the base plate 111 and covers a front side of the battery module 200 and a rear member 130 that is coupled to a rear part of the base plate 111 and covers a rear side of the battery module 200. A discharge hole 140 may be formed in the rear member 130.

The battery pack housing 110 may include a support member 150 that is supported by the base plate 111. The support member 150 may include a first support member 160 and a second support member 170.

The first support member 160 may extend in the leftward/rightward direction of the base plate 111 between the front member 120 and the rear member 130. A plurality of first support members 160 may be provided and may be disposed to be spaced apart from each other in the forward/rearward direction of the base plate 111.

The second support member 170 may connect the front member 120 and the rear member 130 and may extend in the forward/rearward direction of the base plate 111. A plurality of second support members 170 may be provided and may be disposed to be spaced apart from each other along the leftward/rightward direction of the base plate 111. The second support member 170 may extend to cross the first support member 160.

The second support member 170 may include a pair of second side support members 170a that are coupled to a circumferential part of the base plate 111 and a second middle support member 170b that is disposed in parallel to the second side support members 170a between the pair of second side support members 170a.

In this way, the first support member 160 and the second support member 170 may define a module accommodating space 112 that is coupled to the base plate 111, and in which the plurality of battery modules 200 are accommodated, in an interior of the battery pack housing 110.

Furthermore, the module accommodating space 112 may be partitioned to accommodate the battery modules 200 as the first support member 160 and the second support member 170 extend to cross each other.

The battery module 200 may be accommodated in any one of the partitioned module accommodating spaces 112, and a front side and a rear side thereof may be covered by, among the plurality of first support members 160, a pair of first support members 160. The battery module 200 may be accommodated in any one of the partitioned module accommodating spaces 112 and a left side and a right side thereof may be covered by, among the plurality of second support members 170, a pair of second support members 170.

A busbar 116 may be provided on an upper side of the second middle support member 170b except for, among the plurality of second support members 170, the second side support member 170a. The busbar 116 may be configured to connect a control module (not illustrated) that is adjacent to the front member 120 and the rear member 130 and the battery module 200 or to connect the battery modules 200.

Meanwhile, the battery modules 200 accommodated in an interior of the battery pack housing 110 may be vulnerable to a fire. In more detail, when the plurality of battery modules 200 are disposed adjacent to each other and a fire occurs in one battery module 200, a thermal runaway phenomenon in which a fire also occurs in the adjacent battery module 200 may occur.

To prevent this phenomenon, the battery pack 100 according to embodiments of the present disclosure may guide the high-temperature gas to an outside of the battery pack housing 110 through the first support member 160 and the second support member 170 disposed between the battery modules 200.

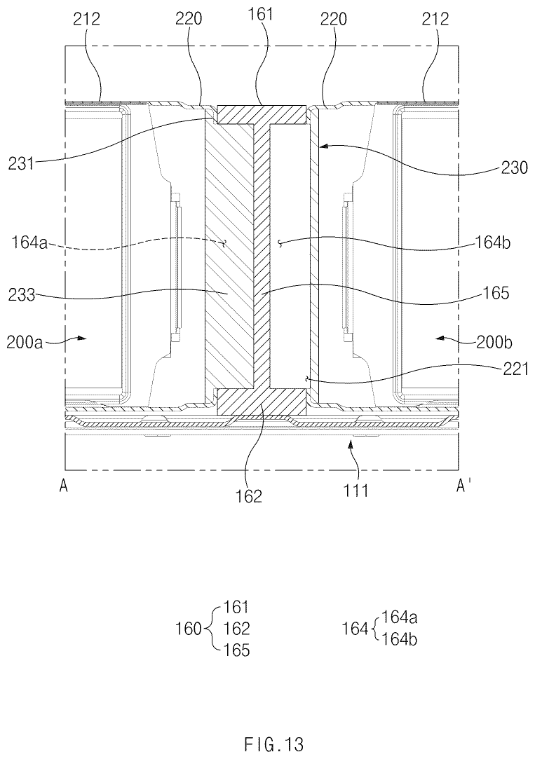

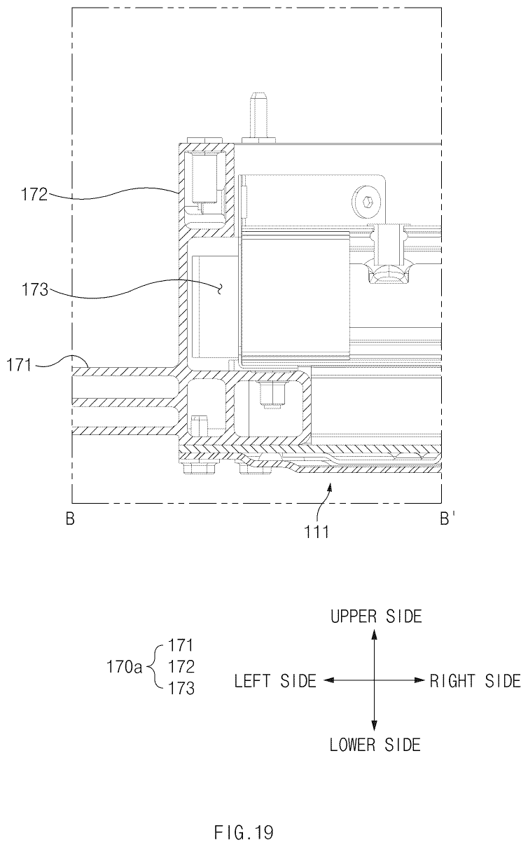

As illustrated in FIG. 4, even when a fire occurs in any one of the battery modules 200, the high-temperature gas may flow through a first venting passage 164 (see FIG. 13) that is formed in an interior of the first support member 160 and a second venting passage 173 (see FIG. 19) that is formed in an interior of the second support member 170, and it may be discharged to an outside of the battery pack housing 110 through the discharge hole 140.

Then, the reason why the first venting passage 164 and the second venting passage 173 are formed in the first support member 160 and the second support member 170, respectively, may be that an upper cooling water channel and a lower cooling water channel are formed on an upper side or a lower side of the battery module 200.

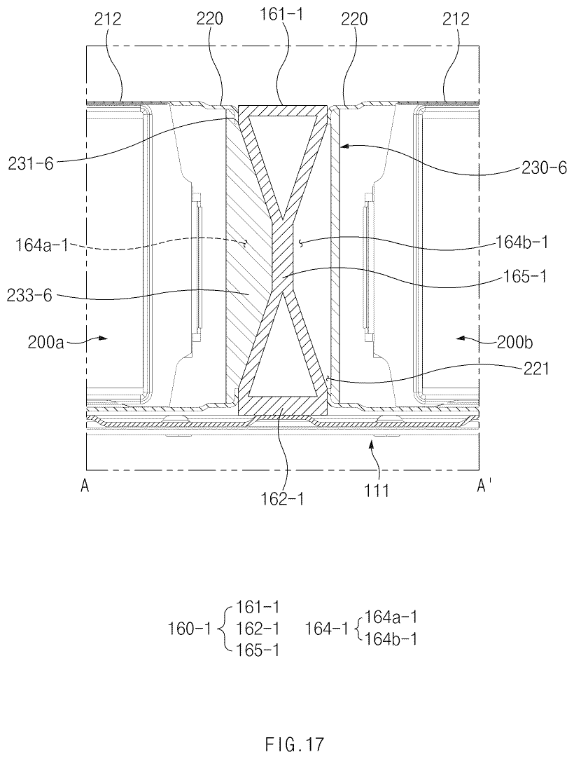

The battery module 200 may include a first battery module 200a and a second battery module 200b that face each other with the first support member 160 being interposed therebetween. The principle of preventing the high-temperature gas from flowing from the first battery module 200a to the second battery module 200b will be described later with reference to FIGS. 13 and 17.

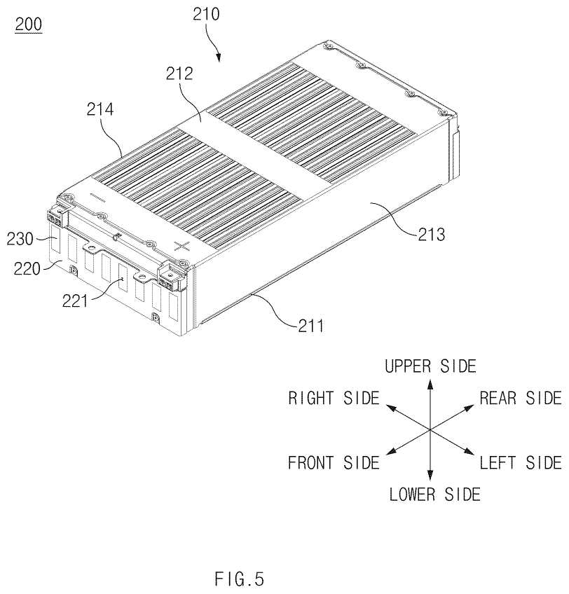

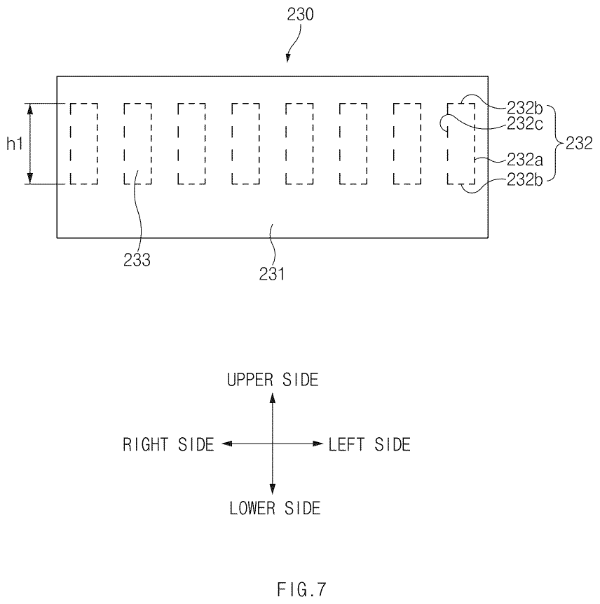

FIG. 5 is a perspective view of the battery module according to an embodiment of the present disclosure. FIG. 6 is a transverse cross-sectional view of the battery module according to an embodiment of the present disclosure. FIG. 7 is a schematic view of a side cover having a perforated part according to an embodiment of the present disclosure.

Referring to FIGS. 5 to 7, the battery module 200 may include the plurality of battery cells 201 that are arranged in the first direction that is any one of the leftward/rightward directions and a module housing 210 that covers the plurality of battery cells 201.

The module housing 210 may include a base frame 211 that covers a lower side of the plurality of battery cells 201 and an upper frame 212 that covers an upper side of the plurality of battery cells 201. The module housing 210 may include a first side frame 213 that covers a left side of the plurality of battery cells 201 and a second side frame 214 that covers a right side of the plurality of battery cells 201.

The module housing 210 may include a venting frame 220 that covers the plurality of battery cells 201 in the second direction that crosses the first direction of the plurality of battery cells 201. The venting frame 220 may cover the plurality of battery cells 201 on a front side or a rear side of the module housing 210 which faces the first support member 160 (see FIG. 4). The venting frame 220 may define the plurality of venting holes 221 that are arranged in the leftward/rightward direction.

A side cover 230 that is supported by the venting frame 220 and covers a side of the plurality of battery cells 201 in the second direction that is perpendicular to the first direction may be provided in the interior of the module housing 210. The side cover 230 may be disposed between the venting frame 220 and the plurality of battery cells 201. The side cover 230 may be formed in the form of a sheet formed of a fire-resistant material.

A perforated part 232 that is formed along a periphery of an area that faces a venting hole 221 and includes a plurality of perforated areas that are spaced apart from each other may be formed in the side cover 230.

In other words, the side cover 230 may include a cover part 231 that is disposed on a front side or a rear side of the plurality of battery cells 201 between the first side frame 213 and the second side frame 214 and is supported by the venting frame 220 and a perforated part 232 that is formed in the cover part 231 and includes a plurality of perforated areas.

The perforated part 232 may be formed along a circumference of a cover area 233 that is cut away from the cover part 231 by the high-pressure gas resulting from a fire that occurs in any one of the plurality of battery cells 201. The cover area 233 may correspond to the shape of the venting hole 221 or may be formed to be smaller in size than the venting hole 221. In this specification, a height of the cover area 233 in the upward/downward direction is defined as h1.

The perforated part 232 may include a first perforated part 232a that extends along the third direction that crosses the first direction and the second direction and a pair of second perforated parts 232b that extend from opposite ends of the first perforated part 232a in a direction that crosses the first perforated part 232a. Here, the third direction may be the upward/downward direction.

The pair of second perforated parts 232b may extend from the opposite ends of the first perforated part 232a in the first direction or an opposite direction to the first direction. That is, the pair of second perforated parts 232b may extend leftward or rightward in parallel to each other from the opposite ends of the first perforated part 232a.

The perforated part 232 may include a third perforated part 232c that connects two opposite ends that are formed on opposite sides of ends of the pair of second perforated parts 232b which are connected to the first perforated part 232a. The third perforated part 232c may extend in parallel to the first perforated part 232a, but the present disclosure is not limited thereto.

Then, a ratio of a section in which the plurality of perforated areas are formed in the first perforated part 232a to a length of the first perforated part 232a in the third direction may be formed to be greater than a ratio of a section in which the plurality of perforated areas are formed in the third perforated part 232c to a length of the third perforated part 232c in the third direction.

According to this structure, among the plurality of perforated parts 232 arranged in the first direction, the first perforated part 232a that is adjacent to a battery cell 201 in which a fire occurred may be completely cut away from the cover part 231, but the third perforated part 232c may not be cut away from the cover part 231. Accordingly, the cover area 233 having a height h1 is not completely separated from the cover part 231 and may guide a flow direction of the gas that is vented to an outside of the module housing 210 through the venting hole 221.

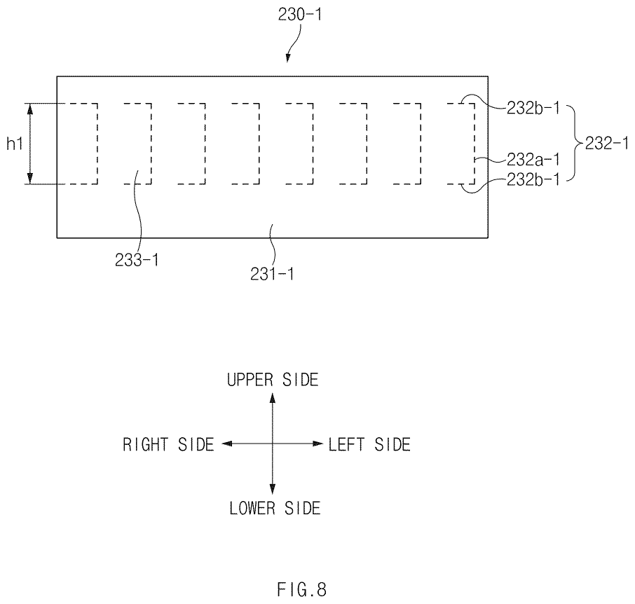

FIG. 8 is a schematic view of a side cover having a perforated part according to another embodiment of the present disclosure.

Referring to FIG. 8, a perforated part 232-1 that is formed in the cover part 231-1 is formed along a periphery of an area that faces the venting hole 221 (see FIG. 5) and includes a plurality of perforated areas that are spaced apart from each other may be formed in the side cover 230-1.

The perforated part 232-1 may include a first perforated part 232a-1 that extends along the third direction that crosses the first direction and the second direction and a pair of second perforated parts 232b-1 that extends from opposite ends of the first perforated part 232a-1 in a direction that crosses the first perforated part 232a-1. Here, the third direction may be the upward/downward direction.

The pair of second perforated parts 232b-1 may extend from opposite ends of the first perforated part 232a-1 in the first direction or an opposite direction to the first direction. That is, the pair of second perforated parts 232b-1 may extend leftward and rightward from the opposite ends of the first perforated part 232a-1 in parallel to each other.

In the structure of FIG. 8, the third perforated part may not be provided compared to the structure of FIG. 7. In this case, it may be understood that the perforated part 232-1 illustrated in FIG. 8 has a substantially “U” shape rather than a closed curve shape unlike in FIG. 7.

Even with this structure, as among the plurality of perforated parts 232-1 arranged in the first direction, the first perforated part 232a-1 and the second perforated part 232b-1 that are adjacent to the battery cell 201 (see FIG. 6) in which the fire occurred are cut away from the cover part 231-1, the cover area 233-1 may be rotated from the cover part 231-1. Then, because the cover area 233-1 having a height h1 is not completely separated from the cover part 231-1, a flow direction of the gas that is vented to an outside of the module housing 210 through the venting hole 221 may be guided.

For the description that has not been mentioned in FIG. 8, the description in FIG. 7 may be used.

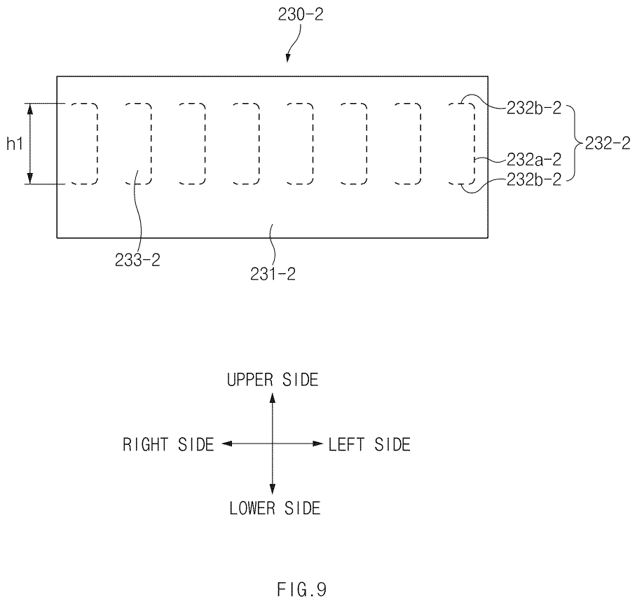

FIG. 9 is a schematic view of a side cover having a perforated part according to another embodiment of the present disclosure.

Referring to FIG. 9, a perforated part 232-2 that is formed in the cover part 231-2 is formed along a periphery of an area that faces the venting hole 221 (see FIG. 5) and includes a plurality of perforated areas that are spaced apart from each other.

The perforated part 232-2 may include a first perforated part 232a-2 that extends along the third direction that crosses the first direction and the second direction and a pair of second perforated parts 232b-2 that extend from opposite ends of the first perforated part 232a-2 in a direction that crosses the first perforated part 232a-2. Here, the third direction may be the upward/downward direction.

Then, compared to FIG. 8, in FIG. 9, a connected portion of the first perforated part 232a-2 and the second perforated part 232b-2 and an opposite end of the second perforated part 232b-2 to one end connected to the first perforated part 232a-2 may be formed to be bent in a direction that faces another second perforated part 232b-2. Even with this structure, as among the plurality of perforated parts 232-2 arranged in the first direction, the first perforated part 232a-2 and the second perforated part 232b-2 that are adjacent to the battery cell 201 (see FIG. 6) in which the fire occurred is cut away from the cover part 231-2, a cover area 233-2 may be rotated from the cover part 231-2. Then, because the cover area 233-2 having a height h1 is not completely separated from the cover part 231-2, a flow direction of the gas vented to the outside of the module housing 210 through the venting hole 221 may be guided.

For a description that has not been mentioned in FIG. 9, the description in FIG. 8 may be used.

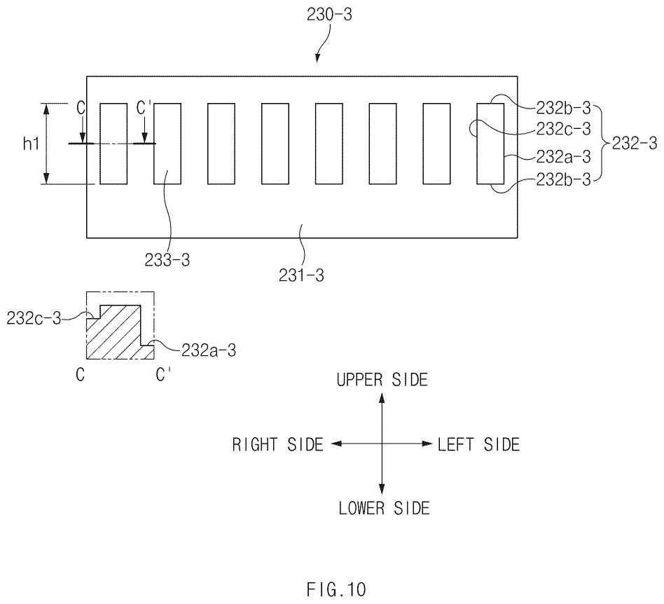

FIG. 10 is a schematic view of a side cover having a notch part according to an embodiment of the present disclosure.

Referring to FIG. 10, a notch part 232-3 that is formed along a periphery of an area that faces the venting hole 221 (see FIG. 5) and has a thickness that is smaller than a periphery thereof may be formed in a side cover 230-3.

In other words, the side cover 230-3 may include a cover part 231-3 that is disposed on a front side or a rear side of the plurality of battery cells 201 (see FIG. 6) between the first side frame 213 and the second side frame 214 and is supported by the venting frame 220 and a notch part 232-3 that is formed in the cover part 231-3 and includes a plurality of notch areas.

The notch part 232-3 may be formed along a circumference of a cover area 233-3 which is cut away from the cover part 231-2 by the high-pressure gas due to a fire generated in any one of the plurality of battery cells 201. The cover area 233-3 may correspond to a shape of the venting hole 221 or may be formed to be smaller in size than the venting hole 221.

Meanwhile, when the notch part 232-3 is formed in the side cover 230-3, the side cover 230-3 may be formed of a metal plate. For example, the side cover 230-3 may be formed of aluminum. Then, it may be difficult to form a perforated part in the side cover 230-3 formed of a metal plate, and thus, the notch part 232-3 that is relatively easy to manufacture may be formed.

The notch part 232-3 may include a first notch part 232a-3 that extends along the third direction that crosses the first direction and the second direction and a pair of second notch parts 232b-3 that extend from opposite ends of the first notch part 232a-3 in a direction that crosses the first notch part 232a-3. Here, the third direction may be the upward/downward direction.

The pair of second notch parts 232b-3 may extend from opposite ends of the first notch part 232a-3 in the first direction or in an opposite direction to the first direction. That is, the pair of second notch parts 232b-3 may extend leftward or rightward from the opposite ends of the first notch part 232a-3 in parallel to each other.

The notch part 232-3 may include a third notch part 232c-3 that connects two opposite ends of the pair of second notch parts 232b-3 which are formed on opposite sides to ends connected to the first notch part 232a-3. The third notch part 232c-3 may extend in parallel to the first notch part 232a-3, but the present disclosure is not limited thereto.

Then, as illustrated in a transverse cross-sectional view taken along line C-C′, a thickness of the notch part 232-3 may be formed to be smaller than that of a periphery thereof, and a thickness of the third notch part 232c-3 may be formed to be greater than that of the thicknesses of the first notch part 232a-3 and a second notch part 232b-3.

According to this structure, among the plurality of notch parts 232-3 arranged in the first direction, the first notch part 232a-3 that is adjacent to the battery cell 201 in which the fire occurred is completely cut away from the cover part 231-3, the third notch part 2320-3 may not be cut away from the cover part 231-3. Accordingly, the cover area 233-3 having a height hi is not completely separated from the cover part 231-3, and thus, a flow direction of the gas vented to an outside of the module housing 210 through the venting hole 221 may be guided.

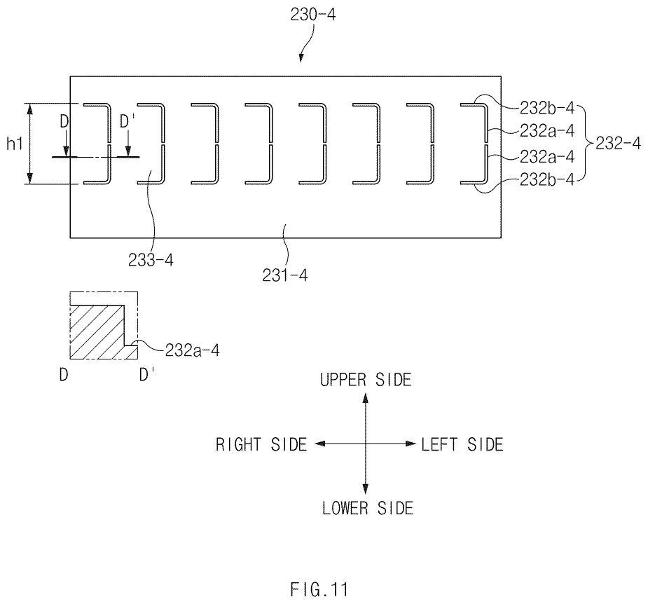

FIG. 11 is a schematic view of a side cover having a notch part according to another embodiment of the present disclosure.

Referring to FIG. 11, a notch part 232-4 that is formed in the cover part 231-4 and includes a plurality of notch areas that are formed along a periphery of an area that faces the venting hole 221 (see FIG. 5) and are spaced apart from each other may be formed in a side cover 230-4.

As illustrated in a transverse cross-sectional view taken along line D-D′, a thickness of the notch part 232-4 may be formed to be smaller than that of a periphery thereof.

The notch part 232-4 may include a first notch part 232a-4 that extends along the third direction that crosses the first direction and the second direction and a pair of second notch parts 232b-4 that extend from opposite ends of the first notch part 232a-4 in a direction that crosses the first notch part 232a-4. Here, the third direction may be the upward/downward direction.

The pair of second notch parts 232b-4 may extend from opposite ends of the first notch part 232a-4 in the first direction or in an opposite direction to the first direction. That is, the pair of second notch parts 232b-4 may extend leftward or rightward from opposite ends of the first notch part 232a-4 in parallel to each other.

In the structure of FIG. 11, the third notch part may not be provided compared to the structure of FIG. 10. Furthermore, in the structure of FIG. 11, the first notch part 232a-4 may include a plurality of notch areas. That is, portions other than the notch areas may be formed between the plurality of notch areas in the first notch part 232a-4. In this case, it may be understood that the notch part 232-4 illustrated in FIG. 11 has a substantially “U” shape.

Even with this structure, as among the plurality of notch parts 232-4 arranged in the first direction, the first notch part 232a-4 and a second notch part 232b-4 that are adjacent to the battery cell 201 in which the fire occurred (see FIG. 6) are cut away from the cover part 231-4, the cover area 233-4 may be rotated from the cover part 231-4. Then, because the cover area 233-4 having a height h1 is not completely separated from the cover part 231-4, a flow direction of the gas vented to the outside of the module housing 210 through the venting hole 221 may be guided.

For a description that has not been mentioned in FIG. 11, the description in FIG. 10 may be used.

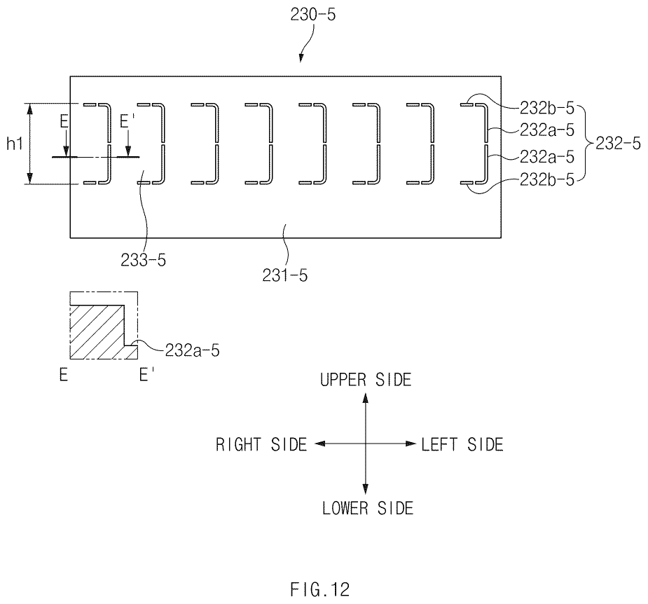

FIG. 12 is a schematic view of a side cover having a notch part according to another embodiment of the present disclosure.

Referring to FIG. 12, a notch part 232-5 that is formed in the cover part 231-5 and includes a plurality of notch areas that are formed along a periphery of an area that faces the venting hole 221 (see FIG. 5) and are spaced apart from each other may be formed in a side cover 230-5.

Referring to a transverse cross-sectional view taken along line E-E′, a thickness of the notch part 232-5 may be formed to be smaller than that of a periphery thereof.

In the notch part 232-5 of FIG. 12, a plurality of notch areas may be formed not only in a first notch part 232a-5 but also in the pair of second notch parts 232b-5, and thus, an area other than the notch areas may be formed between the plurality of notch areas.

The structure and effects of the cover area 233-5 having a height h1 in FIG. 12 may be the same as the structure and effects of the cover area 233-4 in FIG. 11, and for a description that has not been mentioned in FIG. 12, the description in FIG. 11 may be used.

FIG. 13 is a longitudinal cross-sectional view of the battery pack taken along line A-A′ illustrated in FIG. 4 when a fire occurs in the first battery module of an embodiment of the present disclosure.

Referring to FIGS. 4, 5, and 13, the first support member 160 may be disposed between the first battery module 200a and the second battery module 200b.

The first support member 160 may extend in the first direction, and the second support member 170 may cross the first support member 160 and extend in the second direction. The first support member 160 may define the first venting passage 164 that extends in the first direction in an interior thereof, and the second support member 170 may define the second venting passage 173 (see FIG. 19) that is communicated with the first venting passage 164 and extends in the second direction in an interior thereof.

Then, the first support member 160 may define the first venting passage 164 that is opened toward the venting holes 221 of the first and second battery modules 200a and 200b and is communicated with the venting hole 221 in an interior thereof. The first support member 160 may be configured to cover outsides of the two side covers 230 between the two side covers 230 of the first and second battery modules 200a and 200b which face each other.

The first venting passage 164 may be communicated with the venting hole 221 of the first battery module 200a and the venting hole 221 of the second battery module 200b, respectively. In more detail, the first venting passage 164 may include a first module venting passage 164a that is communicated with the venting hole 221 of the first battery module 200a and a second module venting passage 164b that is communicated with the venting hole 221 of the second battery module 200b. The first module venting passage 164a and the second module venting passage 164b may be spaced apart from each other.

The first support member 160 may include a first support wall 161, a second support wall 162 that is spaced downward apart from the first support wall 161, and a partition wall 165 that connects the first support wall 161 and the second support wall 162 and separates the first module venting passage 164a and the second module venting passage 164b.

A front part of the first support wall 161, the partition wall 165, and a front part of the second support wall 162 may define a first module venting passage 164a, and a rear part of the first support wall 161, the partition wall 165, and a rear part of the second support wall 162 may define a second module venting passage 164b. However, without being limited to the illustration of the drawing, the front part of the first support wall 161 and the rear part of the first support wall 161 may be formed to be spaced apart from each other by the partition wall 165, and the front part of the second support wall 162 and the rear part of the second support wall 162 may be formed to be spaced apart from each other by the partition wall 165.

According to this structure, the first module venting passage 164a and the second module venting passage 164b that are communicated with the first battery module 200a and the second battery module 200b, respectively, may be separated from each other, and as a result, the high-temperature gas generated from any one of the first battery module 200a or the second battery module 200b in which the fire occurred may be prevented from flowing to the other. Accordingly, it is possible to prevent a thermal runaway between adjacent battery modules 200 from occurring.

Meanwhile, a height between the first support wall 161 and the second support wall 162 may be h1 or greater than h1, and a cross section of the first support member 160 may have an “I” shape. This cross section may correspond to the cover areas 233, 233-1, 233-2, 233-4, and 233-5 of the side covers 230, 230-1, 230-2, 230-3, 230-4, and 230-5 of FIGS. 7 to 12 described above.

For example, when a fire occurs in an interior of a first battery module 200a, as illustrated in FIG. 13, any one of the plurality of cover areas 233, 233-1, 233-2, 233-3, 233-4, and 233-5 may be rotated about portions that are not cut away from the cover parts 231, 231-1, 231-2, 231-3, 231-4, and 231-5 and may be inserted into an interior of the first module venting passage 164a.

Accordingly, at least a portion of the first module venting passage 164a may be closed by the cover areas 233, 233-1, 233-2, 233-3, 233-4, and 233-5.

According to this structure, the first module venting passage 164a may guide the high-temperature gas to flow only in the first direction or in an opposite direction to the first direction. That is, according to embodiments of the present disclosure, it is possible to prevent high-temperature gas from flowing into the other battery module 200 formed on an opposite side to a side on which the high-temperature gas flows, and thus, a thermal runaway may be effectively prevented.

Furthermore, a direction in which the above-described cover areas 233, 233-1, 233-2, 233-3, 233-4, and 233-5 are rotated about portions that are not separated from the cover parts 231, 231-1, 231-2, 231-3, 231-4, and 231-5 may be adjusted.

Then, a plurality of second support members 170 may be provided to be spaced apart from each other along the first direction. The cover areas 233, 233-1, 233-2, 233-3, 233-4, and 233-5 may be rotated to allow the high-temperature gas to flow toward, among the plurality of second support members 170, the closest second support member 170.

Under this structure, the pair of second perforated parts 232b, 232b-1, and 232b-2 of FIGS. 7 to 9 may extend in a direction that crosses the first perforated part 232a, 232a-1, and 232a-2 toward an opposite direction to the second venting passage 173 that is closest to opposite ends of the first perforated part 232a, 232a-1, and 232a-2. That is, a pair of second perforated parts 232b, 232b-1, and 232b-2 may extend from opposite ends of the first perforated part 232a, 232a-1, and 232a-2 toward the opposite direction to the closest second support member 170.

Furthermore, the pair of second notch parts 232b-3, 232b-4, and 232b-5 of FIGS. 10 to 12 may extend in a direction that crosses the first notch part 232a-3, 232a-4, and 232a-5 toward an opposite direction to the second venting passage 173 that is closest to the opposite ends of the first notch part 232a-3, 232a-4, and 232a-5. That is, the pair of second notch parts 232b-3, 232b-4, and 232b-5 may extend from opposite ends of the first notch part 232a-3, 232a-4, and 232a-5 toward an opposite direction to, among the plurality of second support members 170, the closest second support member 170.

According to this structure, it is possible to prevent the high-temperature gas from flowing into the other battery module 200 disposed in the first direction of the first battery module 200a or in an opposite direction to the first direction, and thus, prevention of a thermal runaway phenomenon may be improved.

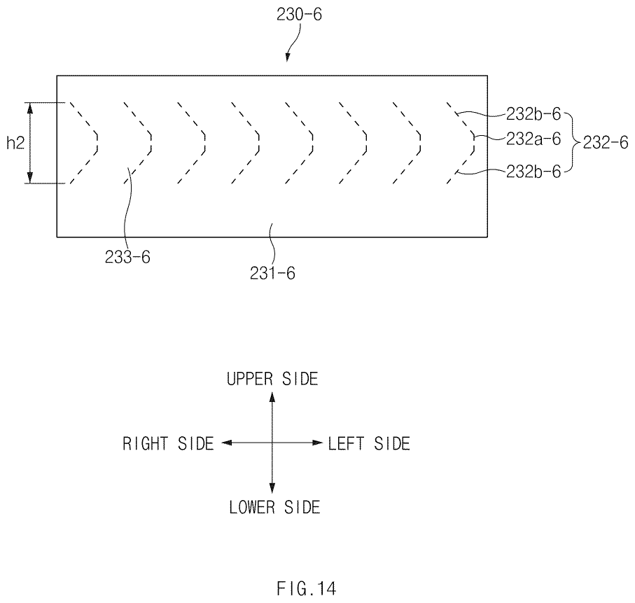

FIG. 14 is a schematic view of a side cover having a perforated part according to another embodiment of the present disclosure.

Referring to FIG. 14, a perforated part 232-6 including a plurality of perforated areas that are formed along a periphery of an area that faces the venting hole 221 (see FIG. 5) and are spaced apart from each other may be formed in a side cover 230-6. Then, the side cover 230-6 may be formed in the form of a sheet that is formed of a fire-resistant material.

The perforated part 232-6 may include a pair of second perforated parts 232b-6 that extend from opposite ends of the first perforated part 232a-6 in a direction that crosses the first perforated part 232a-6.

Unlike the second perforated part 232b of FIG. 7, the pair of second perforated parts 232b-6 of FIG. 14 may extend from the opposite ends of the first perforated part 232a-6 in a direction that becomes closer or more distant as it goes in the first direction or an opposite direction to the first direction.

FIG. 14 illustrates the pair of second perforated parts 232b-6 extending from the opposite ends of the first perforated part 232a-6 in a direction that becomes more distant as it goes in the first direction or an opposite direction to the first direction, but the present disclosure is not limited thereto.

A cover area 233-6, a circumferential portion of which is formed along the first perforated part 232a-6 and the pair of second perforated parts 232b-6, may be provided in a trapezoidal shape, unlike in FIG. 7. Then, a length of a long side of the cover area 233-6 in the third direction may be formed to be h2. Unlike this, a length of a short side of the cover area 233-6 in the third direction may be smaller than h2.

The cover area 233-6 may be rotated about a portion that is not separated from the cover part 231-6 by a high pressure. That is, the cover area 233-6 may be rotated about on the long side.

A shape of the venting hole 221 of the battery module 200 (see FIG. 5) may also correspond to a shape of the cover area 233-6. Furthermore, although the shape of the cover area 233-6 will be described later, this may be for forming the shape of the cover area 233-6 such that it corresponds to the first module venting passage 164a-1 (see FIG. 17) or the second module venting passage 164b-1 to close the first module venting passage 164a-1 or the second module venting passage 164b-1.

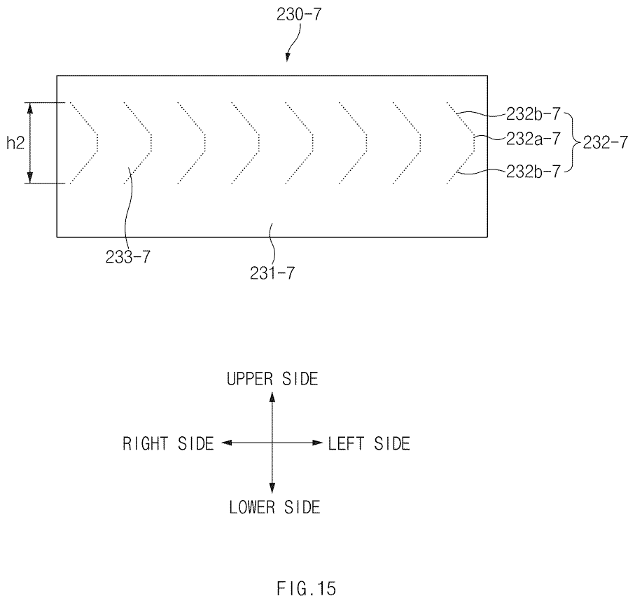

FIG. 15 is a schematic view of a side cover having a perforated part according to another embodiment of the present disclosure.

Referring to FIG. 15, a ratio of a section of a perforated part 232-7 formed on a side cover 230-7, in which the perforated areas are formed, in the cover part 231-7 may be formed to be large compared to the perforated part 232-6 of FIG. 14.

In other words, ratios of sections of the first perforated part 232a-7 and the second perforated part 232b-7 of FIG. 15, in which the perforated areas are formed, may be larger compared to the first perforated part 232a-6 and the second perforated part 232b-6 of FIG. 14. The effects of the cover area 233-7 of FIG. 15 may be the same as the effects of the cover area 233-6 of FIG. 14, and the structure of FIG. 14 may be used for a structure that has not been described in FIG. 15.

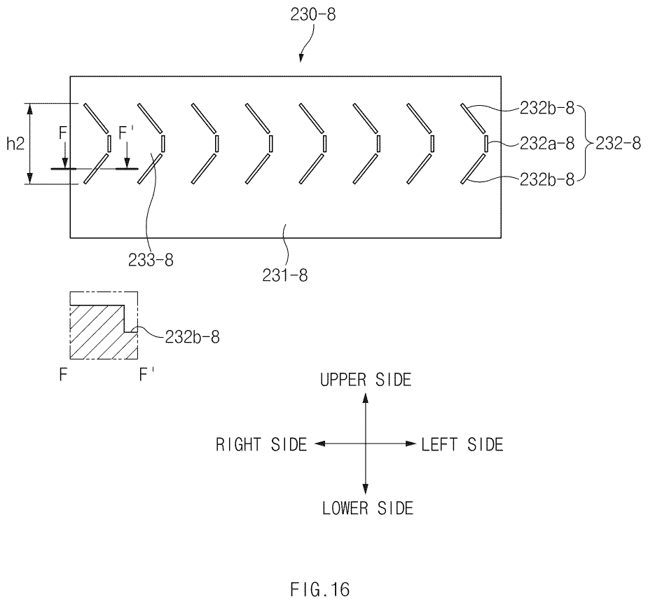

FIG. 16 is a schematic view of a side cover having a notch part according to another embodiment of the present disclosure.

Referring to FIG. 16, a notch part 232-8 that is formed along a periphery of an area that faces the venting hole 221 (see FIG. 5) and has a thickness that is smaller than that of a periphery thereof may be formed in the side cover 230-8. Then, unlike the side cover 230-6 of FIG. 14, the side cover 230-8 may be formed of a metal (an example: aluminum) plate.

Referring to a transverse cross-sectional view taken along line F-F′, the notch part 232-8 may be formed with a thickness that is smaller than that of a periphery thereof.

A second notch part 232b-8 of FIG. 16 may include a pair of second notch parts 232b-8 that extend from opposite ends of a first notch part 232a-8 in a direction that crosses the first notch part 232a-8.

Unlike the second notch part 232b-4 of FIG. 11, the pair of second notch parts 232b-8 of FIG. 16 may extend from the opposite ends of the first notch part 232a-8 in a direction that becomes closer to or more distant from each other as it goes in the first direction or the opposite direction to the first direction.

FIG. 16 illustrates that the pair of second notch parts 232b-8 extend from the opposite ends of the first notch part 232a-8 in the first direction or the opposite direction to the first direction, but the present disclosure is not limited thereto.

The cover area 233-8, a circumferential portion of which is formed along the first notch part 232a-8 and the pair of second notch parts 232b-8, may be provided in a trapezoidal shape, unlike FIG. 11. Then, a length of the long side of the cover area 233-8 in the third direction may be formed to be h2. Unlike this, a length of the short side of the cover area 233-8 in the third direction may be smaller than h2. When the notch part 232-8 is separated from a cover part 231-8 due to the high-pressure gas, the cover area 233-8 may be rotated about the long side that is not separated from the cover part 231-8. For a structure that has not been described in FIG. 16, the structure of FIG. 14 may be used.

FIG. 17 is a longitudinal cross-sectional view of the battery pack taken along line A-A′ illustrated in FIG. 4 when a fire occurs in the second battery module in another embodiment of the present disclosure.

Referring to FIGS. 4 and 17, the first support member 160-1 may be disposed between the first battery module 200a and the second battery module 200b. As described above, the first support member 160-1 may extend in the first direction. The first support member 160-1 may define the first venting passage 164-1 that extends in the first direction in an interior thereof, and the second support member 170 (see FIG. 19) may define the second venting passage 173 that is communicated with the first venting passage 164-1 and extends in the second direction in an interior thereof.

Then, the first support member 160-1 may define a first venting passage 164-1 that is opened toward the venting holes 221 of the first and second battery modules 200a and 200b and communicates with the venting holes 221 in an interior thereof. The first support member 160-1 may be configured to cover outsides of the two side covers 230-6 between the two facing side covers 230-6 of the first and second battery modules 200a and 200b, respectively.

The first venting passage 164-1 may be communicated with the venting hole 221 of the first battery module 200a and the venting hole 221 of the second battery module 200b, respectively. In more detail, the first venting passage 164-1 may include a first module venting passage 164a-1 that is communicated with the venting hole 221 of the first battery module 200a and a second module venting passage 164b-1 that is communicated with the venting hole 221 of the second battery module 200b. The first module venting passage 164a-1 and the second module venting passage 164b-1 may be spaced apart from each other.

The first support member 160-1 may include a first support wall 161-1, a second support wall 162-1 that is spaced downward from the first support wall 161-1, and a partition wall 165-1 that is provided between the first support wall 161-1 and the second support wall 162-1.

The first support wall 161-1 may be a wall for accommodating the busbar 116 (see FIG. 2). The second support wall 162-1 may be a wall that is supported by the base plate 111. The partition wall 165-1 may connect the first support wall 161-1 and the second support wall 162-1 and may separate the first module venting passage 164a-1 and the second module venting passage 164b-1.

Partition walls 165-1 may extend downward from opposite ends of the first support wall 161-1 to become closer to each other and may be connected to each other. The partition walls 165-1 may extend to become more distant again as they go downward from the connected portion, and they may be formed such that they become more distant toward the opposite ends of the second support wall 162-1.

The first module venting passage 164a-1 and the second module venting passage 164b-1 communicated with the first battery module 200a and the second battery module 200b by the partition walls 165-1, respectively, may be separated from each other, and thus, the high-temperature gas generated in any one of the first battery module 200a or the second battery module 200b in which the fire occurred may be prevented from flowing to the other. Accordingly, it is possible to prevent a thermal runaway between adjacent battery modules 200 from occurring.

Meanwhile, heights of the first module venting passage 164a-1 and the second module venting passage 164b-1 may be h2 or may be greater than h2. The shapes of the first and second module venting passages 164a-1 and 164b-1 may correspond to the trapezoidal cross-sections of the cover areas 233-6, 233-7, and 233-8 of the side covers 230-6, 230-7, and 230-8 of FIGS. 14 to 16 described above. For example, as illustrated in FIG. 17, when a fire occurs in an interior of the first battery module 200a, any one of the plurality of cover areas 233-6, 233-7, and 233-8 may be rotated from the cover part 231-6, 231-7, and 231-8 and may be inserted into the first module venting passage 164a-1. Accordingly, at least a portion of the first module venting passage 164a-1 may be closed by the cover areas 233-6, 233-7, and 233-8.

According to this structure, the first module venting passage 164a-1 may guide the high-temperature gas such that it flows only in the first direction or in an opposite direction to the first direction. That is, according to embodiments of the present disclosure, it is possible to prevent the high-temperature gas from flowing into the other battery module 200 formed on an opposite side to a side on which the high-temperature gas flows, and thus, prevention of a thermal runaway may be more effective.

Furthermore, even in this structure, a direction in which the above-described cover areas 233-6, 233-7, and 233-8 are rotated from the cover parts 231-6, 231-7, and 231-8 may be adjusted.

That is, the pair of second perforated parts 232b-6 and 232b-7 in FIGS. 14 and 15 may extend from the opposite ends of the first perforated parts 232a-6 and 232a-7 in a direction that crosses the first perforated parts 232a-6 and 232a-7 toward an opposite direction to the closest second venting passage 173. That is, the pair of second perforated parts 232b-6 and 232b-7 may extend from opposite ends of the first perforated parts 232a-6 and 232a-7 toward the opposite direction to, among the plurality of second support members 170, the closest second support member 170.

Furthermore, the pair of second notch parts 232b-8 of FIG. 16 may extend from the opposite ends of the first notch part 232a-8 in a direction that crosses the first notch part 232a-8 toward an opposite direction to the closest second venting passage 173. That is, the pair of second notch parts 232b-8 may extend from the opposite ends of the first notch part 232a-8 toward the opposite direction to, among the plurality of second support members 170, the second support member 170 that is closest thereto.

According to this structure, it is possible to prevent the high-temperature gas from flowing into the other battery module 200 disposed in the first direction of the first battery module 200a or in an opposite direction to the first direction, and thus, prevention of a thermal runaway phenomenon may be improved.

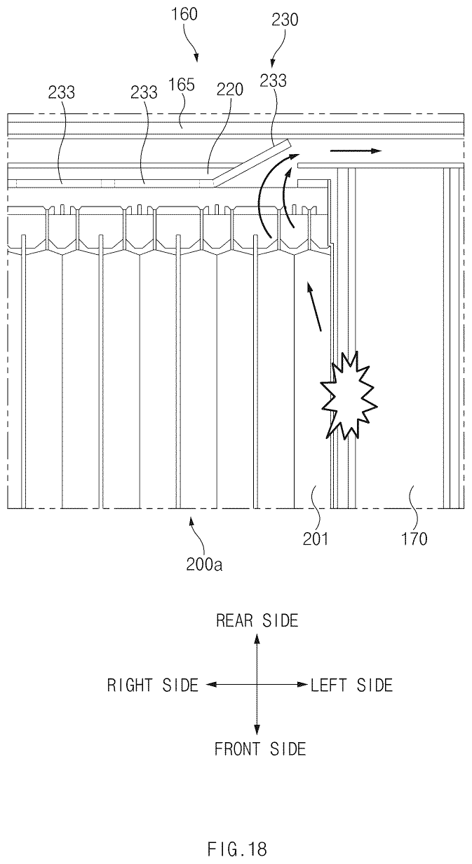

FIG. 18 is a schematic view of the cover area that closes the first module venting passage according to an embodiment of the present disclosure. FIG. 19 is a longitudinal cross-sectional view taken along line B-B′ illustrated in FIG. 4.

Referring to FIGS. 18 and 19, according to the above-described principle, the high-temperature gas caused by the battery cell 201 in which the fire occurred in the first battery module 200a may be rotated by any one of the plurality of cover areas 233 arranged in the first direction from the cover part 231 (see FIG. 7). Then, the cover area 233 may be rotated such that the high-temperature gas is directed to the closest second support member 170 (see FIG. 4). Because the cover area 233 may close the first module venting passages 164a and 164a-1 (see FIGS. 13 and 17), the high-temperature gas does not flow in the opposite direction to the closest second support member 170.

The high-temperature gas that flows through the first venting passage 164 may flow in the forward/rearward direction of the battery pack housing 110 through the second venting passage 173 of the second support member 170 and may be discharged to an outside of the battery pack housing 110.

Among the plurality of second support members 170, the second side support member 170a coupled to a circumference of the base plate 111 may include a support part 172 that is coupled to the base plate perpendicularly thereto while defining the second venting passage 173 in an interior thereof and a fixing part 171 that extends from the support part 172 to an outside of the base plate 111 and is configured to be fixed to a vehicle body frame (not illustrated).

According to the above-described structure, when a fire occurs in the battery cell 201, not only a fire may be delayed in the adjacent battery module 200, but also heat transfer to the adjacent battery cell 201 may be delayed whereby a thermal runaway phenomenon of the battery pack 100 (see FIG. 1) may be prevented.

According to the present technology, because the fluid generated in the interior of the battery module may be guided to an outside of the battery module and the battery pack housing with the structure for solving the above-described problems, a thermal runaway phenomenon of the battery pack may be prevented.

Furthermore, according to the present technology, because the fluid generated in the interior of the battery module is guided to the closest support member, heat transfer between the battery cells may be delayed.

In addition, according to the present technology, because the cover area formed in the side cover of the battery module closes the first module venting passage or the second module venting passage, a fire in the adjacent battery module may be prevented.

In addition, various effects that are directly or indirectly recognized through the present disclosure may be provided.

The above description is a simple exemplary description of the technical spirits of the present disclosure, and a person of ordinary skill in the art to which the present disclosure pertains may make various corrections and modifications without departing from the essential characteristics of the present disclosure.

Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. A battery module comprising:
a plurality of battery cells arranged in a first direction;
a module housing covering the plurality of battery cells on a side of the plurality of battery cells in a second direction crossing the first direction, the module housing comprising a venting frame defining a venting hole; and
a side cover supported by the venting frame and covering the side of the plurality of battery cells in the second direction, wherein the side cover comprises a perforated part comprising a plurality of perforated areas disposed along a periphery of an area facing the venting hole and spaced apart from each other.

2. The battery module of claim 1, wherein the perforated part comprises:
a first perforated part extending along a third direction crossing the first direction and the second direction; and
a pair of second perforated parts extending from opposite ends of the first perforated part in a direction crossing the first perforated part.

3. The battery module of claim 2, wherein the pair of second perforated parts extend from the opposite ends of the first perforated part in the first direction or an opposite direction to the first direction.

4. The battery module of claim 2, wherein the pair of second perforated parts extend from the opposite ends of the first perforated part, the pair of second perforated parts becoming closer to or more distant from each other as they go in the first direction or in an opposite direction to the first direction.

5. The battery module of claim 2, wherein:
the perforated part further comprises a third perforated part connecting two opposite ends of the pair of second perforated parts disposed on opposite sides from ends of the second perforated parts that are connected to the first perforated part; and
a ratio of a section in which the plurality of perforated areas are disposed in the first perforated part to a length of the first perforated part is greater than a ratio of a section in which the plurality of perforated areas are disposed in the third perforated part to a length of the third perforated part.

6. A battery module comprising:
a plurality of battery cells arranged in a first direction;
a module housing covering the plurality of battery cells on a side of the plurality of battery cells in a second direction crossing the first direction, the module housing comprising a venting frame defining a venting hole; and
a side cover supported by the venting frame and covering the side of the plurality of battery cells in the second direction, wherein the side cover comprises a notch part, the notch part comprising a plurality of notch areas disposed along a periphery of an area facing the venting hole and spaced apart from each other, and the notch part having a thickness that is smaller than a periphery of the notch part.

7. The battery module of claim 6, wherein the notch part comprises:
a first notch part extending along a third direction crossing the first direction and the second direction; and
a pair of second notch parts extending from opposite ends of the first notch part in a direction crossing the first notch part.

8. The battery module of claim 7, wherein the pair of second notch parts extend from the opposite ends of the first notch part in the first direction or an opposite direction to the first direction.

9. The battery module of claim 7, wherein the pair of second notch parts extend from the opposite ends of the first notch part, the pair of second notch parts becoming closer to or more distant from each other as they go in the first direction or in an opposite direction to the first direction.

10. The battery module of claim 7, wherein:
the notch part further comprises a third notch part connecting two opposite ends of the pair of second notch parts that are disposed on opposite sides from ends of the second notch parts that are connected to the first notch part; and
a thickness of the third notch part is greater than a thickness of the first notch part.

11. A battery pack comprising:
a battery pack housing defining a module accommodating space in an interior thereof; and
a battery module accommodated in the module accommodating space, wherein the battery module comprises:
a plurality of battery cells arranged in a first direction;
a module housing covering the plurality of battery cells on a side of the plurality of battery cells in a second direction crossing the first direction, the module housing comprising a venting frame defining a venting hole; and
a side cover supported by the venting frame and covering a side of the plurality of battery cells in the second direction, wherein the side cover comprises a perforated part disposed in the side cover, the perforated part comprising a plurality of perforated areas disposed along a periphery of an area facing the venting hole and spaced apart from each other or a notch part having a thickness that is smaller than that of a periphery of the notch part.

12. The battery pack of claim 11, wherein the battery pack housing further comprises:
a base plate supporting the battery module; and
a support member supported by the base plate and extending in the first direction or the second direction to partition the module accommodating space, wherein the support member defines a venting passage in an interior thereof, the venting passage being opened toward the venting hole of the battery module accommodated in the module accommodating space to be communicated with the venting hole.

13. The battery pack of claim 12, wherein the support member comprises:
a first support member extending in the first direction; and
a second support member crossing the first support member and extending in the second direction.

14. The battery pack of claim 13, wherein:
each of the first support member and the second support member defines a first venting passage extending in the first direction and a second venting passage communicated with the first venting passage and extending in the second direction; and
the first support member covers an outside of the side cover.

15. The battery pack of claim 14, wherein the perforated part comprises:
a first perforated part extending along a third direction crossing the first direction and the second direction; and
second perforated parts extending from opposite ends of the first perforated part in a direction crossing the first perforated part to face an opposite direction to the second venting passage.

16. The battery pack of claim 15, wherein:
a plurality of second support members are disposed to be spaced apart from each other along the first direction; and
the second perforated parts extend from the opposite ends of the first perforated part toward an opposite direction to a closest second support member from among the plurality of second support members.

17. The battery pack of claim 14, wherein the notch part comprises:
a first notch part extending along a third direction crossing the first direction and the second direction; and
a pair of second notch parts extending from opposite ends of the first notch part in a direction crossing the first notch part to face an opposite direction to the second venting passage.

18. The battery pack of claim 17, wherein:
a plurality of second support members are disposed to be spaced apart from each other along the first direction; and
the second notch parts extend from the opposite ends of the first notch part toward an opposite direction to a closest second support member from among the plurality of second support members.

19. The battery pack of claim 14, wherein:
the battery module comprises a first battery module and a second battery module disposed to face each other with the first support member being interposed therebetween; and
the first venting passage of the first support member is communicated with a first venting hole of the first battery module and a second venting hole of the second battery module.

20. The battery pack of claim 19, wherein:
the first venting passage comprises:
a first module venting passage communicated with the first venting hole of the first battery module; and
a second module venting passage communicated with the second venting hole of the second battery module; and
the first support member comprises:
a first support wall;
a second support wall spaced downward apart from the first support wall; and
a partition wall connecting the first support wall and the second support wall and separating the first module venting passage and the second module venting passage.
